(19) United States
(12) Patent Application Publication
(10) Pub. No.: US 2011/0279959 A1
(43) Pub. Date: Nov. 17, 2011

(54) Computer handling device

(76) Inventor: Manuel Lopez, Azusa, CA (US)

(21) Appl. No.: 13/068,445

(22) Filed: May 10, 2011

Related U.S. Application Data
(60) Provisional application No. 61/395,306, filed on May 11, 2010.

(51) Int. Cl. G06F 1/16

(52) U.S. Cl. 361/679.03

(57) ABSTRACT

A device for handling a handheld computer allows the computer to be securely held in the palm of an operator's hand and be rotated through 360° or held on a flip-out stand to facilitate use by the operator and provide optimal viewing of the computer screen.

### CROSS REFERENCE TO RELATED APPLICATIONS

This application claims priority to U.S. Provisional Application Ser. No. 61/395,306 filed 11 May 2010, which has the same inventor.

### BACKGROUND OF THE INVENTION

1. Field of the Invention

This invention is concerned with computers, and particularly with handling of portable computers.

2. Description of the Related Art

Computers have recently evolved from desktop and laptop devices to handheld devices, such as the Apple iPad (Apple Computer), the HP Slate (Hewlett Packard), the Jooko Tablet (Fusion Garage), and Google Tablet (Google), for example. An operator typically uses such handheld computer devices by gripping an edge of the device with one hand and interacting with the computer via a touch screen with the other hand. This mode of operation is very tiring to the hand gripping the device and tends to produce strain, fatigue and pain, especially in the wrist area of the operator. Furthermore, a computer gripped by the edge is likely to be dropped by the operator and damaged.

A recent patent application publication to T.-C. Kao (US 2004/0226973 filed 14 May 2003), which is hereby incorporated by reference, describes a one-hand-holding aid for a tablet computer, comprising a raised handhold pivotally connected to the back of the tablet computer and a fastening band that wraps around a wrist or elbow of an operator. The one-hand-holding aid of Kao allows the operator to stably hold the tablet computer with only one hand and conveniently adjust the tablet computer to any desired direction or angle. Since the fastening strap wraps around the wrist or elbow of the operator, the Kao device still requires that the operator grip the raised handhold to stabilize the tablet computer, which is tiring to the operator. Since the handhold protrudes from the computer backside, the Kao device must be removed in order to store the tablet computer compactly or use it on a desktop.

### SUMMARY OF THE INVENTION

The invention provides a compact device for securely holding a handheld computer in one hand and rotating the computer for optimal viewing in either the “landscape” or “portrait” mode. The device comprises a computer attachment part, a hand attachment part comprising a palm plate and a hand strap attached thereto, a rotary attachment means between the computer attachment part and the palm plate. The hand strap wraps around the backside of a hand resting on the palm plate so that it is not necessary for the operator to grip the computer or the device of the invention. The device of the invention may further comprise a flip-out computer stand that enables the computer to be positioned on a desktop for use in either a “touch screen” mode (relatively vertical) or a “typing” mode (relatively horizontal).

Further features and advantages of the invention will be apparent to those skilled in the art from the following detailed description, taken together with the accompanying drawings.

### BRIEF DESCRIPTION OF THE DRAWINGS

FIG. 1 depicts an exploded view of a basic device of the invention.

FIG. 2 illustrates use of the device of FIG. 1 in the “handheld” mode.

FIG. 3 depicts an exploded view of the top of a preferred device with a flip-out stand according to the invention from an oblique angle.

FIG. 4 depicts an exploded view of the bottom of the device of FIG. 3 from an oblique angle.

FIG. 5 depicts a side view of the device of FIG. 3 with the flip-out stand retracted.

FIG. 6 depicts the hand attachment part for the device of FIG. 3 with the flip-out stand retracted.

FIG. 7 illustrates use of the device of FIG. 3 in the “handheld” mode (flip-out stand retracted).

FIG. 8 illustrates the procedure for opening (A) and retracting (B) the flip-out stand of device of FIG. 3.

FIG. 9 illustrates the preferred device of FIG. 3 supported by the flip-out stand in the “touch screen” mode.

FIG. 10 illustrates the preferred device of FIG. 3 supported by the flip-out stand in the “typing” mode.

FIG. 11 illustrates conversion of the device of FIG. 3 between the “touch screen” and “typing” modes.

### DETAILED DESCRIPTION OF THE INVENTION

The invention provides a device for handling a rectangular computer having four corners, four peripheral sides, a computer backside and a computer display side, comprising: a computer attachment part attached on the computer backside; a hand attachment part comprising a palm plate and a hand strap attached thereto; and a rotary attachment means between the computer attachment part and the palm plate.

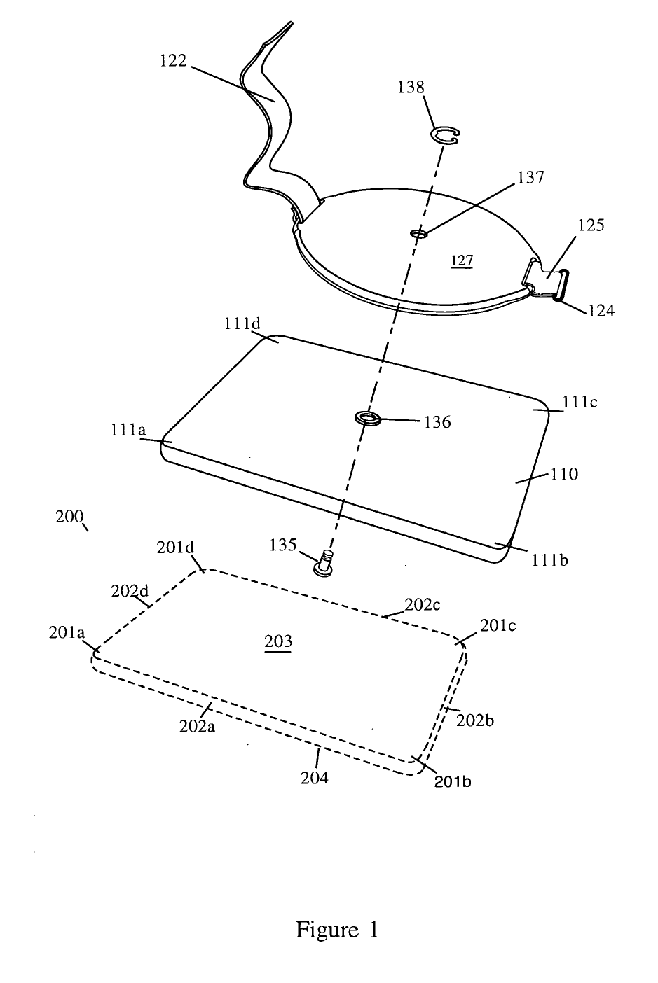

FIG. 1 depicts an exploded view of a basic device of the invention for handling a rectangular computer 200 (not an element of the invention) having four corners 201a-d, four peripheral sides 202a-d, a computer backside 203 and a computer display side 204, comprising: a computer attachment part 110 attached on computer backside 203; a hand attachment part comprising a palm plate 127 and a hand strap 122 attached thereto; and a rotary attachment means between computer attachment part 110 and palm plate 127. For the device of FIG. 1, computer attachment part 110 comprises a shell that substantially covers computer backside 203 and is attached via four plastic clips 111a-d that wrap around peripheral sides 202a-d and overlap the edge of computer display side 204 at corners 201a-d, respectively, so as to provide a reversible attachment to computer 200. Computer attachment part 110 includes openings (not shown) to accommodate electrical connections to computer 200, a USB connection, for example.

Palm plate 127 of FIG. 1 is substantially circular and has a convex outer surface so as to fit the hand of an operator comfortably. Hand strap 122 comprises a strip of hook-and-loop fastener (with an elastic section), one end of which is passed through a slot at the edge of palm plate 127 and fastened via an adhesive (or stitching). Hand strap 122 may further comprise an elongated eyelet 124 attached via a short elastic strip 125 and an adhesive (or stitching) to a slot at the opposite edge of palm plate 121.

The rotary attachment means of FIG. 1 comprises a clevis pin 135 that is passed through a beveled hole 136 in computer attachment part 110 and a hole 137 in palm plate 127, and is retained by a C-clip 138 that fits in a groove in clevis pin 135. Holes 136 and 137 are preferably located at or near the center of computer attachment part 110 and palm plate 121, respectively.

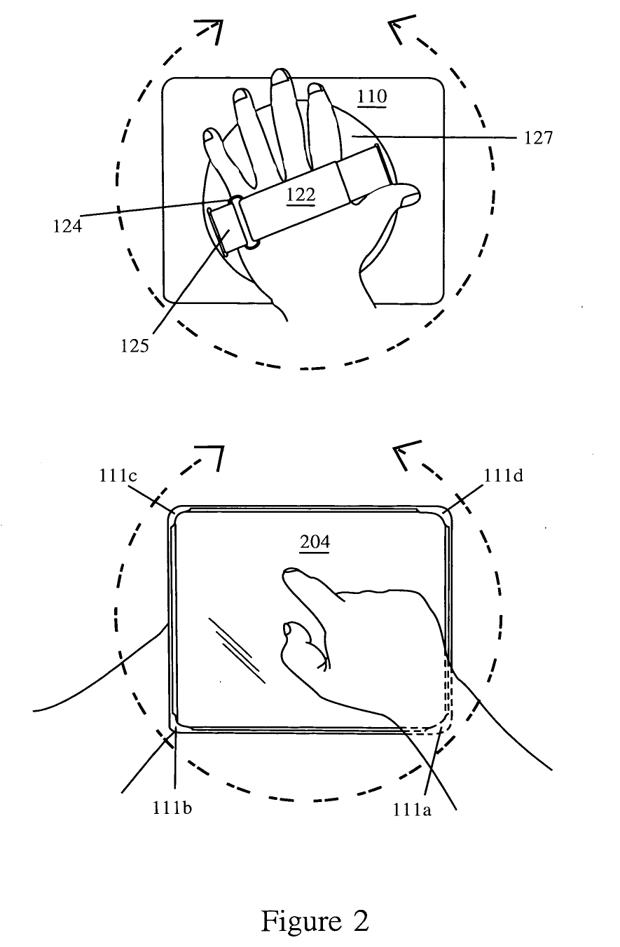

FIG. 2 illustrates use of the device of FIG. 1. The loose end of hand strap 122 is passed through eyelet 124 and is folded back and attached to itself (via the hook-and-loop fastener, such as Velcro®) to form a hand strap loop for attaching the hand of an operator to palm plate 127. Hand strap 122 could be passed directly through the slot in palm plate 127 rather than elongated eyelet 124. An operator inserts a hand under the loop in hand strap 122 so that a palm rests on palm plate 127 and the computer is held firmly without being gripped by the operator. The computer is then flipped over so that display side 204 faces the operator, who may then rotate the computer to a desired orientation for operation in the “touch screen” mode.

The device of the invention may be tailored to fit a wide variety of computers and may also be sized to fit different operator hand sizes. The various parts of the device may comprise any suitable material or combinations of materials. Preferred materials of construction include light-weight metals, aluminum, titanium and alloys thereof, for example, and rigid polymer or composite materials that are relatively strong, light-weight and most preferably injection moldable, polyvinyl chloride (PVC) or polycarbonate, for example.

The computer attachment part preferably covers the computer backside completely so as to serve as a protective covering, but may cover the computer backside partially. The computer attachment part may be attached to the computer by any suitable means, including an adhesive, a hook-and-loop fastener, a wraparound plastic clip overlapping the edge of the computer display side, and combinations thereof. In a preferred embodiment, the computer attachment part is attached on the computer backside via four wraparound plastic clips, one overlapping the edge of the computer display side at each of the four corners of the computer.

The hand strap of the hand attachment part may comprise any suitable material and be attached to the palm plate by any suitable means, including an adhesive, one or more screws or rivets, one or more slots in the palm plate, cloth stitching, and combinations thereof, for example. The hand strap may be fixed in length or adjustable in length (via a hook-and-loop fastener, for example), and may comprise one or more sections of an elastic material.

The palm plate preferably comprises a stiff polymer or composite material, but may also comprise a light weight metal, aluminum, for example. The palm plate may include padding or a coating of a softer material to enhance operator comfort. The palm plate may have any suitable shape, including circular or rectangular, and may include features, finger grips, for example, to facilitate handling. In a preferred embodiment, the palm plate may have the shape of a company logo, the Apple Computer logo (a bitten apple), for example. The outer surface of the palm plate is preferably convex so as to fit the hand of an operator comfortably.

Any suitable rotary attachment means may be employed within the scope of the invention. A preferred rotary attachment means comprises an axle, at least one axle fastener, a hole in the computer attachment part, and a hole in the palm plate. Suitable axles include a rod , a clevis pin, a screw, a bolt, a barbed pin, a rivet, and combinations thereof. Suitable axle fasteners include a C-clip (that fits in a groove in a clevis pin axle), a retaining ring, a cotter pin, a split ring, a nut, a threaded hole, a threaded insert, a barbed pin, and combinations thereof.

In a preferred embodiment, the device of the invention further comprises a flip-out computer stand comprising: a support arm having a first arm end and a second arm end, the first arm end being attached to an edge of the palm plate via a first hinge; and a support arm brace having a first brace end and a second brace end, the first brace end being attached to the second arm end of the support arm via a second hinge and the second brace end having two tabs that fit into and may be moved along grooves along opposite sides of a rectangular slot in the palm plate. The invention enables a computer to be securely held and rotated in one hand or positioned on a desktop for optimal use and viewing by the operator.

### DESCRIPTION OF A PREFERRED EMBODIMENT

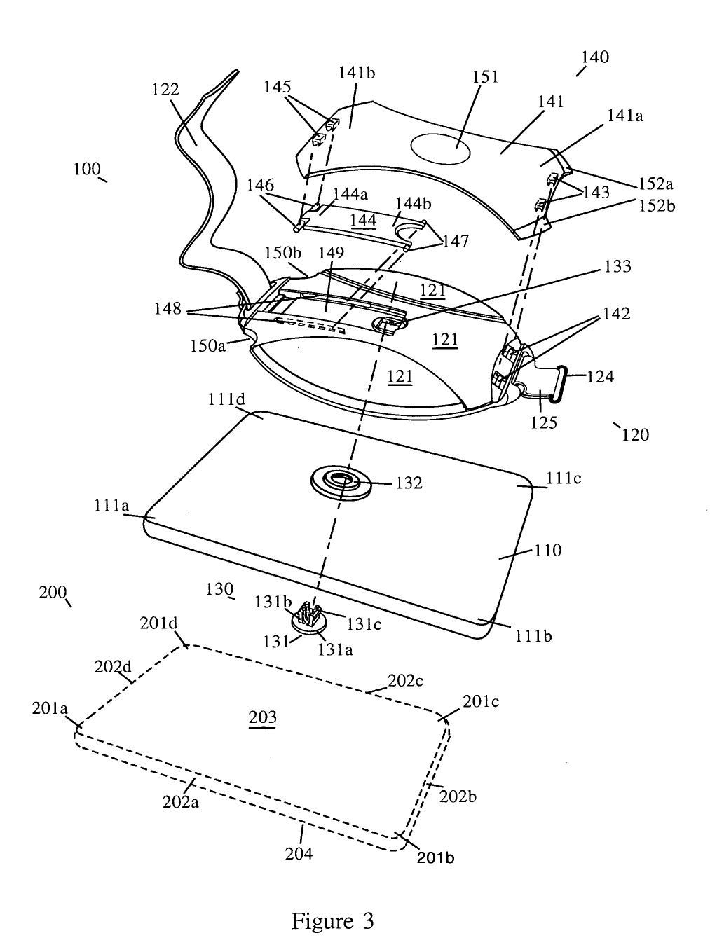

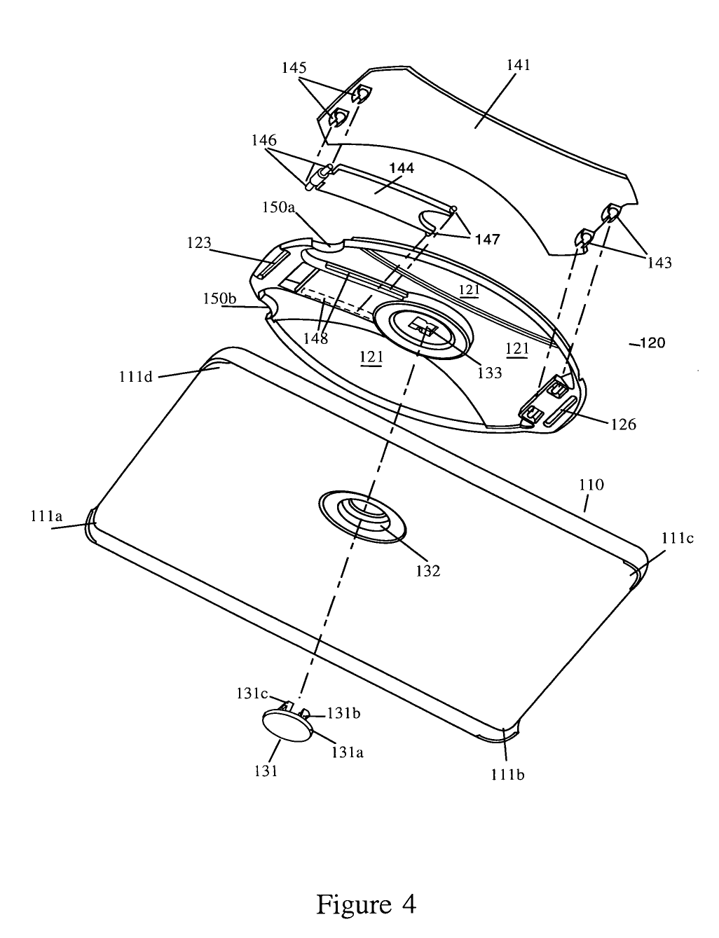

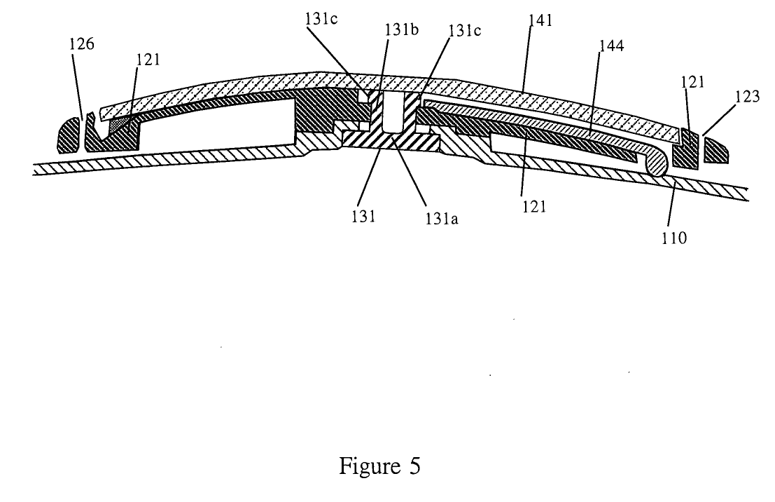

FIGS. 3 and 4 depict exploded views top and bottom of a preferred device of the invention from oblique angles. FIG. 5 depicts a side view of the device of FIGS. 3 and 4 with the flip-out stand retracted. Numbering throughout the figures is consistent.

With reference to FIGS. 3, 4 and 5, the invention provides a device 100 for handling a rectangular computer 200 (not an element of the invention) having four corners 201a-d, four peripheral sides 202a-d, a computer backside 203 and a computer display side 204, comprising: a computer attachment part 110 attached on computer backside 203; a hand attachment part 120 comprising a palm plate 121 and a hand strap 122 attached thereto; a rotary attachment means 130 between computer attachment part 110 and palm plate 121; and a flip-out computer stand 140.

In the preferred embodiment of FIGS. 3-5, computer attachment part 110 covers all of computer backside 203, including a central area, and comprises four clips 111a-d that wrap around the computer peripheral sides 202a-d at corners 201a-d so as to overlap the edge of computer display side 204 and provide a reversible attachment to computer 200. Computer attachment part 110 includes openings (not shown) to accommodate electrical connections to computer 200, a USB connection, for example.

In the preferred embodiment of FIGS. 3-5, palm plate 121 is substantially circular and the outer surface of palm plate 121 is preferably convex so as to fit the hand of an operator comfortably. Hand strap 122 comprises a strip of hook-and-loop fastener (with an elastic section), one end of which is passed through a slot 123 at the edge of palm plate 121 (see FIG. 4) and fastened via an adhesive (or stitching). The other end of hand strap 122 is passed through an elongated eyelet 124 attached via a short elastic strip 125 and an adhesive (or stitching) to a slot 126 at the opposite edge of palm plate 121. Hand strap 122 could be passed directly through slot 126 rather than an elongated eyelet. The loose end of hand strap 122 is folded back and attached to itself (via the hook-and-loop fastener, such as Velcro to form a hand strap loop for attaching the hand of an operator to palm plate 121.

In the preferred embodiment of FIGS. 3-5, rotary attachment means 130 comprises a combination retaining clip/axle 131 having a cylindrical section 131a on one end and a barbed section 131b of smaller cross-sectional diameter with barbs 131c on the other end. Cylindrical section 131a of retaining clip/axle 131 fits into a bevel in a circular beveled hole 132 substantially at the center of computer attachment part 110 such that cylindrical section 131a serves as both an axle and a retaining device. Barbed section 131b passes through a hole 133 in palm plate 121 so that barbs 131c are engaged and prevent retaining clip/axle 131 from being retracted. In the preferred embodiment of FIGS. 3-5, barbed section 131b and hole 133 are rectangular in cross section but may have a different cross-sectional shape, circular, for example.

Flip-out computer stand 140 is preferably integrated into palm plate 121 and comprises: a support arm 141 having a first arm end 141a and a second arm end 141b, first arm end 141a being attached to an edge of palm plate 121 via a first hinge 142/143; and a support arm brace 144 having a first brace end 144a and a second brace end 144b, first brace end 144a being attached to second arm end 141b of support arm 141 via a second hinge 145/146 and second brace end 144b having two tabs (pins) 147 that fit into and may be moved along grooves 148 along opposite sides of a rectangular slot 149 in palm plate 121. First hinge 142/143 and second hinge 145/146 are snap-together hinges comprising pins 142 and 146 that snap into split cylindrical tubes 143 and 145, respectively. The outer surface of support arm 141 of flip-out stand 140 is preferably curved so as to form a continuous smooth surface with palm plate 121 when flip-out stand 140 is retracted. Palm plate 121 preferably includes finger slots 150a and 150b to facilitate opening the flip out stand. Support arm 141 may comprise a flat area 151 and/or polymer coated feet 152a and 152b to stabilize the computer in the “touch screen” and “typing” modes, respectively.

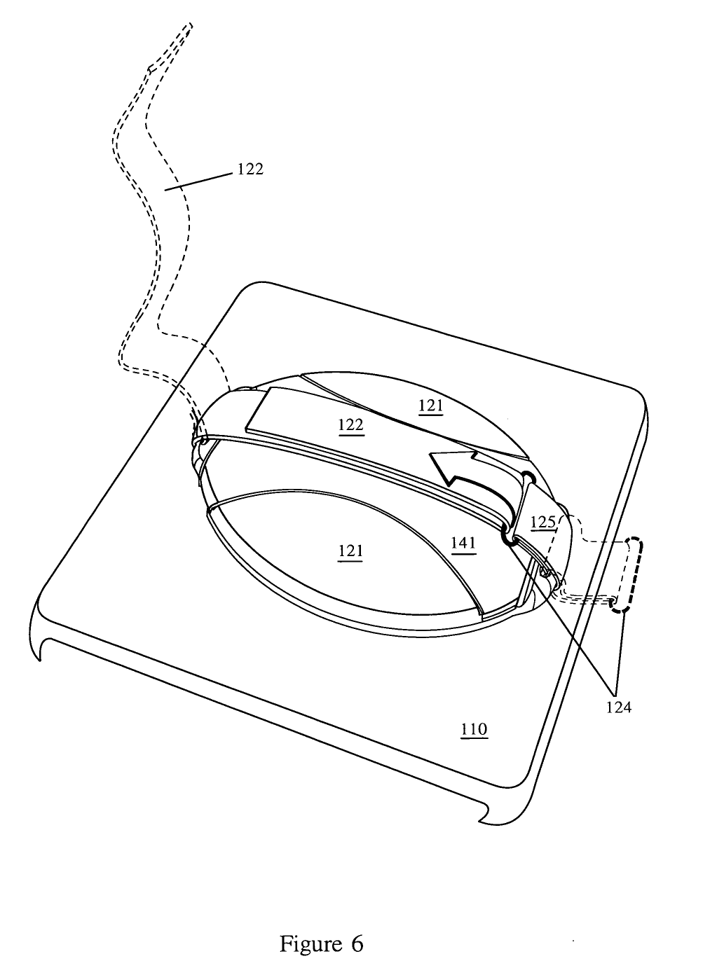

FIG. 6 depicts the hand attachment part for the device of FIG. 3 with the flip-out stand retracted for use with a computer in the “handheld” mode. The loose end of hand strap 122 is passed through elongated eyelet 124, folded back, and fastened with a hook-and-loop fastener.

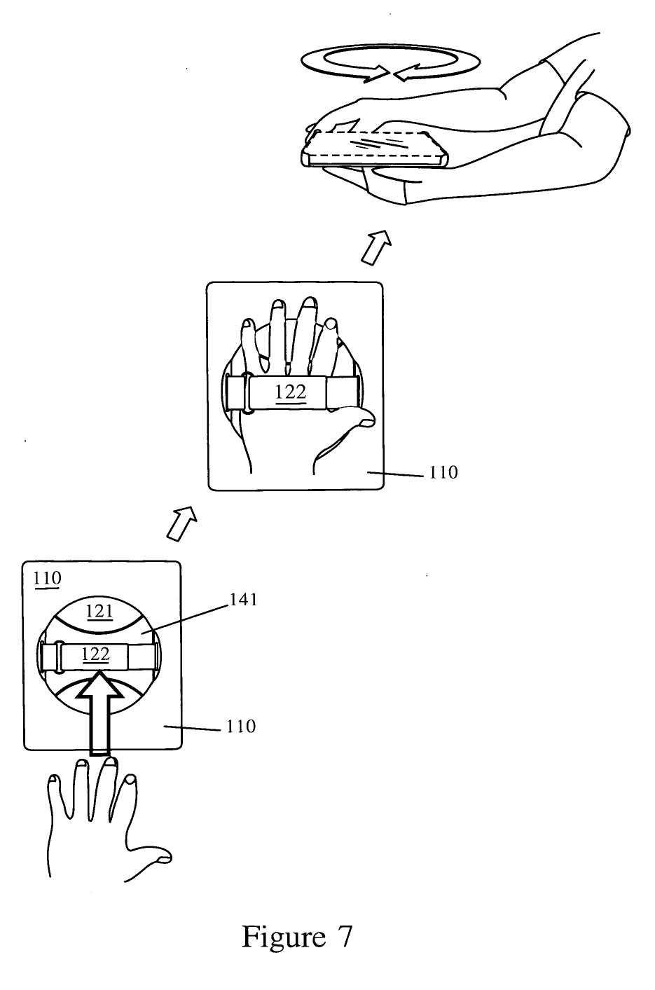

FIG. 7 illustrates use of the device of FIG. 3 in the “handheld” mode (flip-out stand retracted). The operator slips one hand under hand strap 122 so that a palm rests on the palm plate 121, flips the computer over so that the computer display side faces upward, and uses the other hand to rotate the computer to the desired position.

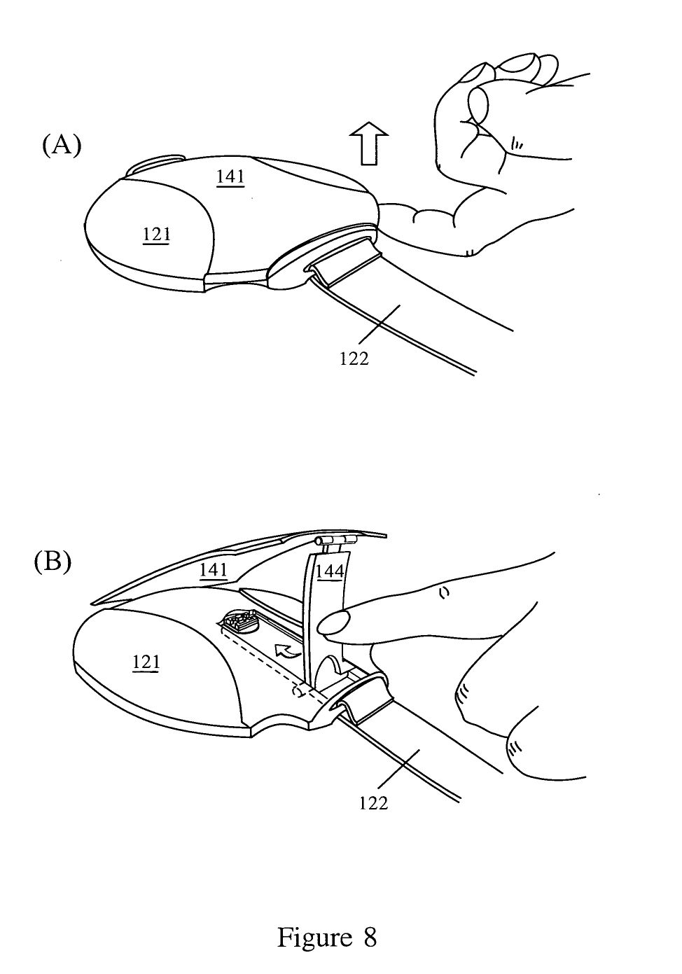

FIG. 8 illustrates the procedure for opening (A) and retracting (B) the flip-out stand of device of FIG. 3.

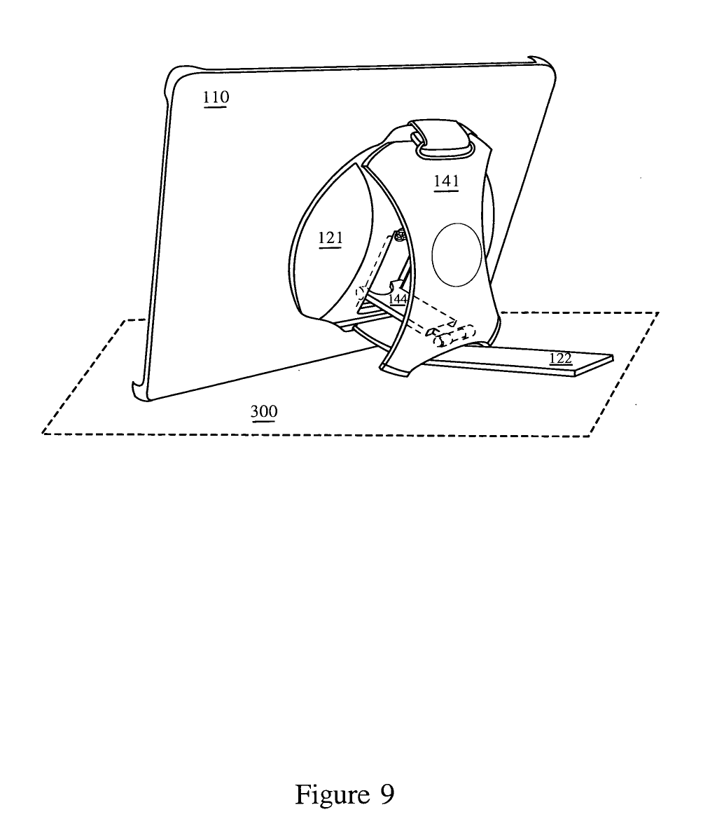

FIG. 9 illustrates the preferred device of FIG. 3 supported by flip-out stand 140 on a desktop 300 in the “touch screen” mode. In this case, hand strap 122 is located at the bottom and the computer is supported on desktop 300 in a relatively vertical position.

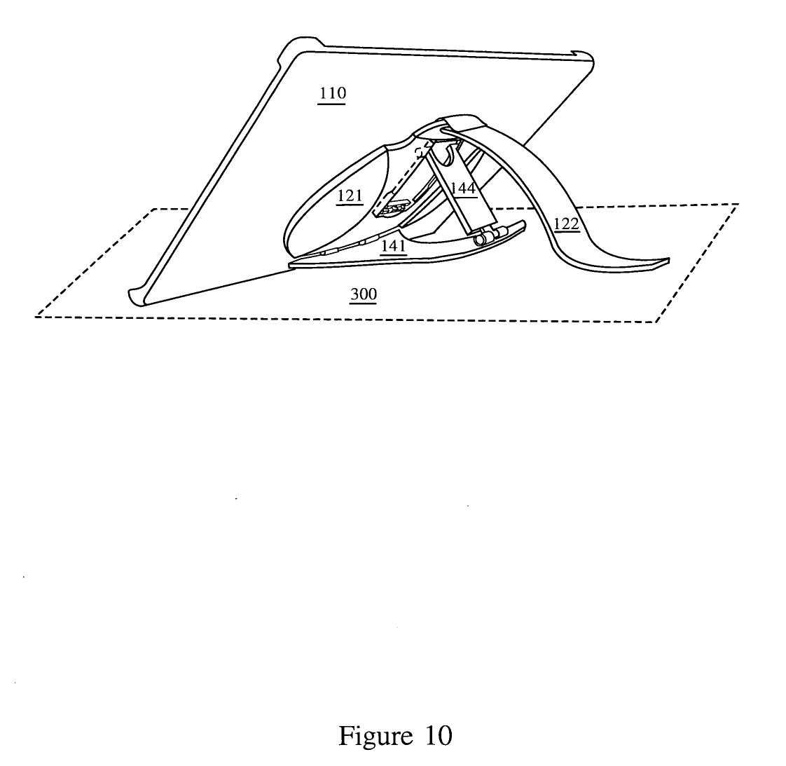

FIG. 10 illustrates the preferred device of FIG. 3 supported by flip-out stand 140 on desktop 300 in the “typing” mode. In this case, hand strap 122 is located at the top and the computer is supported on desktop 300 in a relatively horizontal position suitable for typing on a touch screen.

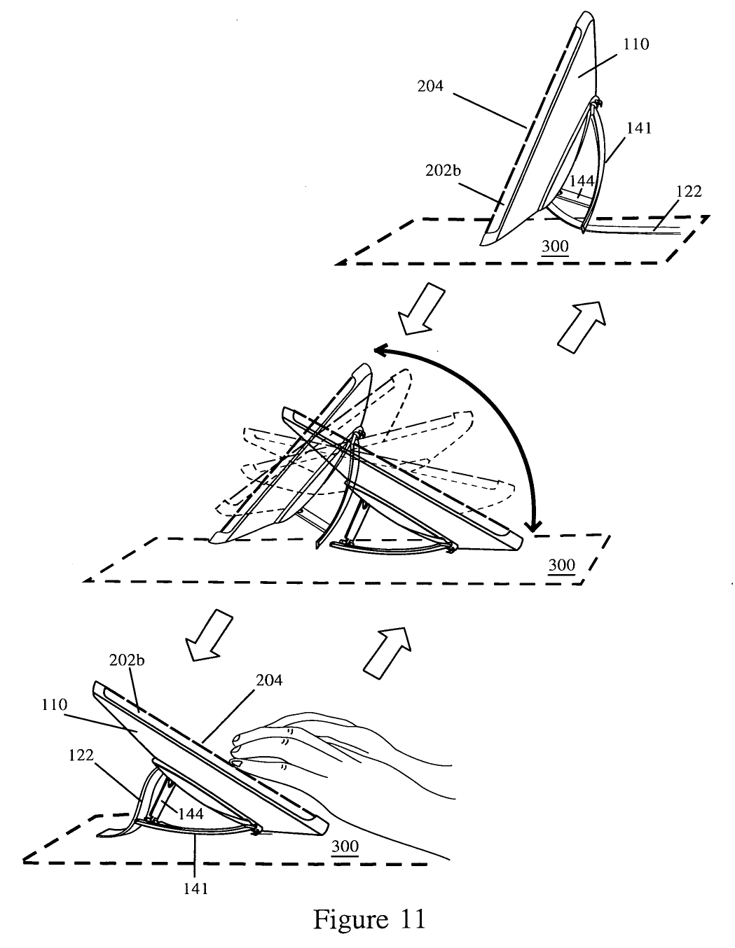

FIG. 11 illustrates conversion of the device of FIG. 3 between the “touch screen” and “typing” modes.

An all-plastic prototype device of the preferred embodiment of FIGS. 3-5 was constructed and successfully tested for an Apple iPad® computer having overall dimensions of 19×24 cm (9.5×7.5 inches). This prototype had a palm plate 13 cm (5.25 inches) in diameter, a support arm approximately 12 cm (4.75 inches) in length, and a support arm brace approximately 5.7 cm (2.25 inches) in length.

The preferred embodiments of the present invention have been illustrated and described above. Modifications and additional embodiments, however, will undoubtedly be apparent to those skilled in the art. Furthermore, equivalent elements may be substituted for those illustrated and described herein, parts or connections might be reversed or otherwise interchanged, and certain features of the invention may be utilized independently of other features. Consequently, the exemplary embodiments should be considered illustrative, rather than inclusive, while the appended claims are more indicative of the full scope of the invention.

I claim:

1. A device for handling a rectangular computer having four corners, four peripheral sides, a computer backside and a computer display side, comprising:
a computer attachment part attached on the computer backside;
a hand attachment part comprising a palm plate and a hand strap attached thereto; and
a rotary attachment means between the computer attachment part and the hand attachment part,
whereby the computer may be securely held and rotated in one hand for optimal use and viewing by the operator.

2. The device of claim 1, wherein the computer attachment part is attached on the computer backside by a means selected from the group consisting of an adhesive, a hook-and-loop fastener, a wraparound plastic clip overlapping the edge of the computer display side, and combinations thereof

3. The device of claim 1, wherein the computer attachment part is attached on the computer backside via four wraparound plastic clips that overlap the edge of the computer display side at each of the four corners of the computer.

4. The device of claim 1, wherein the computer attachment part substantially covers the computer backside.

5. The device of claim 1, wherein the palm plate is substantially circular in shape and has a convex outer surface.

6. The device of claim 1, wherein the palm plate has the shape of a company logo.

7. The device of claim 1, wherein the hand strap comprises an elastic material, a hook-and-loop material, or combinations thereof.

8. The device of claim 1, wherein the rotary attachment means comprises an axle, at least one axle fastener, a hole in the computer attachment part, and a hole in the palm plate.

9. The device of claim 8, wherein the axle is selected from the group consisting of a rod , a clevis pin, a screw, a bolt, a barbed pin, a rivet, and combinations thereof.

10. The device of claim 8, wherein the axle fastener is selected from the group consisting of a C-clip, a retaining ring, a cotter pin, a split ring, a nut, a threaded hole, a threaded insert, a barbed pin, and combinations thereof.

11. The device of claim 1, further comprising:
a flip-out computer stand,
whereby the computer may be positioned on a desktop for optimal use and viewing by the operator.

12. The device of claim 11, wherein the flip-out computer stand comprises,
a support arm having a first arm end and a second arm end, the first arm end being attached to an edge of the palm plate via a first hinge, and
a support arm brace having a first brace end and a second brace end, the first brace end being attached to the second arm end of the support arm via a second hinge and the second brace end having two tabs that fit into and may be moved along grooves along opposite sides of a rectangular slot in the palm plate.

13. A device for handling a rectangular computer having four corners, four peripheral sides, a computer backside and a computer display side, comprising:
a computer attachment part attached on the computer backside;
a hand attachment part comprising a palm plate and a hand strap attached thereto;
a rotary attachment means between the computer attachment part and the hand attachment part; and
a flip-out computer stand,
whereby the computer may be securely held and rotated in one hand or positioned on a desktop for optimal use and viewing by the operator.

14. The device of claim 13, wherein the flip-out computer stand comprises
a support arm having a first arm end and a second arm end, the first arm end being attached to an edge of the palm plate via a first hinge, and
a support arm brace having a first brace end and a second brace end, the first brace end being attached to the second arm end of the support arm via a second hinge and the second brace end having two tabs that fit into and may be moved along grooves along opposite sides of a rectangular slot in the palm plate.

15. A device for handling a rectangular computer having four corners, four peripheral sides, a computer backside and a computer display side, comprising:
a computer attachment part attached on the computer backside;
a hand attachment part comprising a palm plate and a hand strap attached thereto;
a rotary attachment means between the computer attachment part and the hand attachment part; and
a flip-out computer stand, comprising
a support arm having a first arm end and a second arm end, the first arm end being attached to an edge of the hand attachment part via a first hinge, and
a support arm brace having a first brace end and a second brace end, the first brace end being attached to the second arm end of the support arm via a second hinge and the second brace end having two tabs that fit into and may be moved along grooves along opposite sides of a rectangular slot in the palm plate,
whereby the computer may be securely held and positioned in one hand or positioned on a desktop for optimal use and viewing by the operator.
